(19) United States
(12) Patent Application Publication
(10) Pub. No.: US 2024/0240004 A1
(43) Pub. Date: Jul. 18, 2024

(54) METHOD FOR RECYCLING RUBBER UTILIZING A LABYRINTHINE MATERIAL

(71) Applicant: APPIA, LLC, Akron, OH (US)

(72) Inventor: Georg Bohm, Akron, OH (US)

(21) Appl. No.: 18/413,964

(22) Filed: Jan. 16, 2024

Related U.S. Application Data
(60) Provisional application No. 63/479,771, filed on Jan. 13, 2023.

(51) Int. Cl. C08L 17/00; C08J 3/22; C08K 3/06; C08K 3/22; C08K 7/00; C08K 13/04; C08L 21/00

(52) U.S. Cl. CPC C08L 17/00; C08J 3/22; C08K 13/04; C08L 21/00; C08J 2317/00; C08J 2321/00; C08J 2417/00; C08J 2421/00; C08K 3/06; C08K 2003/2296; C08K 7/00; C08K 2201/006; C08K 2201/014; C08L 2207/24; C08L 2310/00; C08L 2312/00

(57) ABSTRACT

A method for recycling a vulcanized rubber compound. The method includes the steps of grinding recycled rubber compound into a plurality of ground rubber particles, adding a suitable amount of labyrinthine or barrier forming material to a fresh rubber compound, mixing the plurality of ground rubber particles with the fresh rubber compound containing the labyrinthine material, and co-vulcanizing the mixture of the plurality of ground rubber particles with the fresh rubber compound containing the labyrinthine material.

### CROSS-REFERENCE TO RELATED APPLICATION

This application claims the benefit of co-pending U.S. Provisional Patent Application Ser. No. 63/479,771, filed on Jan. 13, 2023, titled “LABYRINTHINE MATERIAL FOR USE IN POLYMERIC MATERIALS OR COMPOSITIONS”, the disclosure of which is hereby incorporated by reference in its entirety.

### BACKGROUND

### Technical Field

The disclosed subject matter relates generally to the use of a barrier or labyrinthine material for recycling polymeric materials such as rubber. More particularly, the disclosed subject matter is directed to the reuse or recycling of sulfur-cured rubber compounds or previously vulcanized rubber in a rubber recycling process. More specifically, the disclosed subject matter is directed to a rubber recycling method that utilizes a barrier or labyrinthine material to treat rubber. The barrier or labyrinthine material is a nano or micro-sized platelet that is utilized in conjunction with the recycled sulfur-cured rubber and fresh rubber to control and/or restrict diffusion of vulcanization inducing chemicals, such as sulfur present in the fresh rubber, into the polymeric matrix of the recycled sulfur-cured rubber, which significantly minimizes or eliminates a secondary vulcanization of the recycled sulfur-cured rubber upon subsequent co-curing with the fresh rubber. For example, the barrier or labyrinthine material can be utilized to control and/or restrict the diffusion of vulcanization inducing chemicals, such as sulfur, cure accelerators, etc., into surface-devulcanized ground rubber particles such that they do not enter the vulcanized area of the polymeric matrix to significantly minimize or eliminate a secondary vulcanization of the recycled sulfur-cured rubber upon subsequent co-curing with the fresh rubber. The method for recycling rubber of the disclosed subject matter provides a recycled rubber product with increased performance to those which incorporate untreated and unmodified recycled rubber compounds and comparable performance to rubber products which only incorporate fresh rubber. In addition, the method for recycling rubber of the disclosed subject matter provides increased bond strength between the ground recycled rubber particles and the fresh rubber compound and allows a greater percentage of recycled rubber to be utilized in the rubber recycling process compared to prior art recycling methods, while providing a recycled rubber product with comparable or increased performance. The method for recycling rubber of the disclosed subject matter may also eliminate the need to fully devulcanize the recycled rubber prior to subsequent co-curing of the recycled rubber with fresh rubber, thereby eliminating an often complex and expensive step and decreasing the recycling operation costs.

### Background Art

Rubber compounds, such as those used in vehicle tires, are composite materials that include polymers such as natural rubber or synthetic rubbers that have been blended with reinforcing fillers, such as carbon black or silica, as well as with various additives, such as sulfur. Such rubber compounds are then molded and vulcanized or cured into various shapes dependent on the specific intended use. The curing process of the tire is well known in the industry. It generally includes incorporating in the rubber compounds a mixture of curing agents including an accelerator, sulfur, and accelerator activating compounds, such as stearic acid and zinc oxide, to facilitate the formation of sulfur cross-links upon applying heat to the rubber. Vulcanization results in the creation of a three-dimensional network of intermolecular and intramolecular sulfur cross-links within the rubber phase, which link the various polymer chains to form a dimensionally stable thermoset composite that cannot be reshaped once it has been formed and cured. As a result, the recycling and reuse of vulcanized rubber products, such as from worn tires, is difficult because the vulcanized rubber cannot be reshaped or simply reconstituted by dissolving it in a solvent to form the vulcanized rubber into a new shape. When reference is made to “recycled rubber” or “recycled vulcanized rubber” within this disclosure, it is to be understood that the term refers to previously vulcanized rubber.

However, because of the ever-increasing cost of oil-derived raw materials, such as synthetic rubbers, and due to the environmental waste concerns of such materials, there is considerable interest in the reuse of products, such as worn vulcanized rubber tires made from these materials. For example, millions of used tires and other rubber products are discarded annually and only a minor fraction of them are recycled into new products. The small amounts that are reused are usually first broken up to remove the non-rubber components of the tire, such as steel cords, beads, etc., and the remaining rubber compound is ground up into rubber particles of different sizes for use in a wide variety of applications, such as synthetic turf for football, soccer, and other sport related playing surfaces. Additional applications of these ground-up vulcanized rubber particles include the use of the products in molded or extruded materials such as floor mats, etc. Reuse of such recycled rubber products in high-performance products, such as tires, is limited to exceedingly small quantities because the ground recycled vulcanized rubber particles typically adversely affect key properties vital to the performance of the tire.

More particularly, most of these adverse effects result because the vulcanized ground rubber particles do not dissolve in fresh rubber compounds on a molecular scale, but instead stay intact and often act as defects once the product is processed by molding and vulcanization of the new composition. When reference is made to “fresh rubber” within this disclosure, it is to be understood that the term refers to previously unvulcanized rubber. Two types of defects typically result from incorporating the vulcanized ground rubber particles into fresh rubber compounds. The first relates to a defect generated because of poor bonding between the ground recycled vulcanized rubber particles and the fresh rubber matrix and arises mainly because of insufficient molecular inter-diffusion and crosslinking of the rubber macromolecules in the interface region between the ground recycled vulcanized rubber particles and the fresh rubber matrix. Therefore, when stress is applied to the resulting end product, micro-separations (gaps) will form where the new matrix of fresh rubber separates from the vulcanized ground rubber particles which will subsequently grow into larger propagating cracks, and ultimately potentially cause failure.

The second type of defect arises because the ground recycled vulcanized rubber particles generally will have much higher cross-link density in the end product than the fresh rubber matrix in which they are embedded. More specifically, some of the sulfur and cure accelerators added to the fresh rubber compound for vulcanization will diffuse into the ground recycled vulcanized rubber particles during the mixing, shaping, and vulcanization steps, and cause the ground recycled vulcanized rubber particles to experience significant additional cross-linking or second vulcanization. This second vulcanization results in a much higher cross-link density, a higher modulus, and a significantly lower extension to break in the ground rubber phase. Thus, when the end product is significantly deformed during use, the difference in moduli will cause high interfacial stresses to form that significantly promote the micro-separations (gaps) referred to earlier, and ultimately lead to growing micro-cracks, which can propagate to macro-cracks and ultimately result in product failure. These defects manifest themselves even at relatively low recycled vulcanized ground rubber concentrations, resulting in reduced tensile strength, reduced cut growth, and reduced wear performance. With regard to tire manufacturers, there is a great reluctance on their part to incorporate tire buffings and recycled vulcanized ground rubber particles from whole tires into fresh rubber tire compounds due to the problems described above and the to-be-expected reductions in tire performance.

Studies and experiments have provided a better understanding of the mechanisms involved in the formation of the earlier mentioned defects that had previously prevented successful commercial use of ground rubber particles in new tires and intimated potential new pathways covered in the disclosed subject matter below that can overcome the technical problems cited. These studies draw on the use of rubber laminates that simulate the experience of a cured ground rubber particle made from an end-of-life (“ELT”) tire when embedded in a fresh rubber compound during a co-vulcanization process.

The situation of combining recycled vulcanized rubber with fresh rubber is considerably more complex than situations where only fresh rubber is being utilized. Therefore, in applications where it is desired to combine recycled vulcanized rubber with fresh rubber, such as in applications for tire retreading and the recycling of rubber from spent tires into new tires, the rubber on one side has already been vulcanized and most of the cure chemicals have been depleted while the fresh rubber on the other side is fully prepared for a fresh vulcanization and includes sulfur, cure accelerator and Zinc Oxide, ZnO, etc. When the two layers, combined under pressure are heated to curing temperatures, the sulfur, accelerator, and ZnO present in the fresh rubber will seek means to balance the existing concentration gradients by diffusing from the fresh rubber side that has a reservoir of sulfur, accelerator, and ZnO, etc. to the recycled vulcanized rubber layer where those materials are generally not present. Then, depending on the resulting availability, they will cause additional crosslinking which will hinder intermolecular bonding between the two materials.

It has been found that a small addition of ground recycled rubber, even under ideal conditions where compositions are identical and where the ground recycled rubber has not been subjected to heat and oxidative environments, can still have a substantial effect on the physical properties of the co-cured rubber compound. It is thus believed that the primary cause of performance losses encountered in the recycling of sulfur-cured rubber particles is the additional cross-linking taking place in the rubber particles during the curing of the final rubber composition, as well as insufficient bonding of the sulfur-cured particles to the fresh rubber host compound to which they were added.

Experiments have been carried out to identify and measure the additional cross-linking that occurs during inter-diffusion of cure additives to recycled rubber. For example, experiments have been conducted to simulate the environment in which ground recycled rubber is embedded in a fresh rubber compound during curing.

The experiments have shown that the addition of heat alone will not result in a change in modulus relative to a control, but small increases in modulus occur with the addition of sulfur. Greater increases were realized with the inter-diffusion of a cure accelerator alone, and increases greater than 100% occurred in laminates in which a combination of sulfur and a cure accelerator were added. The consequence is that the addition of cure accelerating ingredients during the vulcanization process increases the number of cross-links within the recycled rubber. Similar increases in moduli are expected to be induced in ground recycled rubber particles during vulcanization of the recycled rubber due to additional cross-linking that may occur.

Prior art rubber recycling processes have addressed some of the potential problems associated with recycling sulfur-cured rubber described above by utilizing a method to first fully devulcanize the previously cured and to be recycled rubber, prior to mixing the recycled rubber with fresh rubber and recurring/reprocessing. Although many different prior art methods of devulcanization exist, the prior art methods generally include first grinding the recycled rubber to a suitable size and then employing a process to reduce the concentration of sulfur cross-links in the recycled rubber before mixing the recycled rubber with fresh rubber and ultimately curing the essentially devulcanized mixture. Although such prior art methods can be effective in avoiding some of the potential issues with utilizing recycled rubber, the methods are generally complex, add significant time and cost to the rubber product manufacturing process, and often result in significant and very undesirable structural changes of the rubber molecules. In addition, the chemical reactivity of such devulcanized recycled rubbers is typically different from that of fresh rubber, and it is generally difficult to achieve the properties of vulcanizates of fresh rubber using such recycled rubber. While the use of untreated recycled rubber for high-performance product applications is generally limited to about 1-2% the use of partially devulcanized recycled rubber may only be slightly larger due to current limitations of the devulcanization process. Therefore, a need exists in the art to find a commercially acceptable tire recycling process.

Rubber recycling processes that address some of the potential problems associated with recycling sulfur-cured rubber and allow a greater percentage of recycled rubber to be utilized in rubber recycling processes compared to prior art recycling methods have been developed. For example, U.S. Pat. No. 11,434,353, which was issued on Sep. 6, 2022, and is assigned to Applicant of the instant application, discloses a method for modifying the surface of recycled sulfur-cured rubber via surface devulcanization, which minimizes alteration of the network structure of the recycled sulfur-cured rubber, while generating strong tack between mixed recycled rubber and fresh rubber to provide optimal adhesion upon subsequent co-curing with fresh rubber. While this method allows a greater percentage of recycled rubber to be utilized in rubber recycling processes compared to prior art recycling methods, a method that further increases the percentage of recycled rubber that can be utilized in rubber recycling processes is desired.

Thus, a need exists in the art for a method for recycling rubber that significantly increases adhesion and bonding between the recycled sulfur-cured rubber and fresh rubber and minimizes or eliminates secondary vulcanization of the recycled sulfur-cured rubber upon subsequent co-curing with fresh rubber. A need also exists in the art for a method for recycling rubber that provides a recycled rubber product with increased performance to those which utilize untreated and unmodified sulfur-cured rubber and comparable performance to rubber products which only use fresh rubber. There also exists a need in the art for a method for recycling rubber that allows a greater percentage of recycled rubber to be utilized in the rubber recycling process compared to prior art recycling methods, while providing a recycled rubber product with comparable or increased performance. In addition, there is also a need in the art for a method for recycling rubber that eliminates the need to fully devulcanize the recycled rubber before subsequent co-curing with fresh rubber to eliminate an often complex and expensive step, thereby decreasing recycling operation costs. The method for recycling rubber of the disclosed subject matter satisfies these needs, and will now be described.

### BRIEF DESCRIPTION OF THE DISCLOSED SUBJECT MATTER

An objective of the disclosed subject matter is to provide a method for recycling vulcanized rubber that minimizes alteration of the network structure of the recycled sulfur-cured rubber while generating strong tack between mixed recycled rubber and fresh rubber to provide optimal adhesion upon subsequent co-curing.

Another objective of the disclosed subject matter is to provide a method for recycling vulcanized rubber that enables ground recycled sulfur-cured rubber particles to be utilized in the rubber recycling process, while providing a recycled rubber product with comparable or increased performance compared to products of rubber recycling methods that require the use of ground recycled sulfur-cured rubber particles with smaller particle sizes.

Yet another objective of the disclosed subject matter is to provide a method for recycling vulcanized rubber which allows a greater percentage of recycled rubber to be utilized in the rubber recycling process compared to prior art rubber recycling methods while providing a recycled rubber product with comparable or increased performance.

Still another objective of the disclosed subject matter is to provide a method for recycling vulcanized rubber which eliminates the need to fully devulcanize the recycled sulfur-cured rubber prior to subsequent co-curing with fresh rubber, thereby eliminating complex and expensive process steps and decreasing the recycling operation costs.

An embodiment of the subject disclosure provides a curable rubber composition including a fresh rubber, a plurality of ground rubber particles and a barrier or labyrinthine material, wherein the barrier or labyrinthine material is capable of forming a barrier to diffusion of sulfur and cure accelerators from the fresh rubber to the ground rubber particles.

Another embodiment of the present invention provides a curable rubber composition as in any embodiment above, wherein the barrier or labyrinthine material is clay, mica, graphene, graphene oxide, functionalized platelet structure(s) thereof, or any other like exfoliable crystalline substance with high surface area/weight ratio.

These objectives and others are achieved by the method of recycling rubber of the subject disclosure, which includes the method steps of providing a recycled rubber compound; grinding the recycled rubber compound to form ground rubber particles; providing a fresh rubber compound; adding a suitable amount of barrier forming material to the fresh rubber compound; mixing the plurality of ground rubber particles with the fresh rubber compound; and co-vulcanizing the mixture of the plurality of ground rubber particles and the fresh rubber compound.

These objectives and others are also achieved by the method for recycling rubber of the subject disclosure, which includes the method steps of providing a recycled rubber compound; grinding the recycled rubber compound to form a plurality of ground rubber particles; providing a fresh rubber compound; adding a barrier forming material to the fresh rubber compound; adding limited amounts of sulfur, cure accelerator, and zinc oxide to the fresh rubber compound; mixing the plurality of ground rubber particles with the fresh rubber compound; inducing a mild vulcanization of the mixture of the plurality of ground rubber particles and fresh rubber compound; grinding the mixture into small diameter particles; mixing additional fresh rubber compound with the small diameter particles; and co-vulcanizing the small diameter particles and the additional fresh rubber compound.

### BRIEF DESCRIPTION OF THE SEVERAL VIEWS OF THE DRAWINGS

An exemplary embodiment of the disclosed subject matter, illustrative of the best mode in which Applicant has contemplated applying the principles of the disclosed subject matter, is set forth in the following description and is shown in the drawings, and will now be described.

FIG. 1 is a graph of results generated from a study comparing moduli increases in a cured rubber stock as a result of additional cross-linking from interdiffusion of curing agents from adjacent fresh rubber with which it was co-cured under various conditions, including under pressure at 160 C for 25 minutes;

FIG. 2 is a graph of results generated from a study comparing the tensile strength of rubber compositions containing ground rubber particles of different types, sizes, and compositions co-cured with a generic carbon black reinforced polybutadiene-based rubber compound (“PBD rubber”);

FIG. 3 is a schematic representation of a laminate study of previously vulcanized rubber co-cured with an untreated fresh rubber strip containing only sulfur and cure accelerator;

FIG. 3A is a schematic representation of the two sides of the previously vulcanized rubber after being pealed from the fresh rubber strip containing only sulfur and cure accelerator and from which dumbbells were cut out to perform stress/strain tests;

FIG. 3B is an image of the B surface of a laminate of recycled rubber that was adjacent to and previously co-cured with a laminate of fresh rubber, peeled from the fresh rubber laminate, and stressed via uniaxial tension, showing the propagation of macro-cracks from micro-cracks on the bonding interface of the recycled rubber laminate as a result of secondary vulcanization of the recycled rubber;

FIG. 4 shows a modulus profile across the interface utilizing micro-indentation measurements of a two-layer laminate that combined an untreated rubber strip of previously vulcanized rubber with a fresh rubber strip;

FIG. 5A shows a modulus profile across the interface utilizing micro-indentation measurements of a two-layer laminate that combined a cured rubber strip and an uncured PBD rubber strip having identical compositions following their co-vulcanization at 160 C for 25 minutes;

FIG. 5B shows a modulus profile across the interface utilizing micro-indentation measurements of a two-layer laminate that a rubber strip of previously vulcanized rubber co-cured with a fresh rubber strip containing 2 weight percentage (wt %) graphene oxide in accordance with Example I;

FIG. 6A is a pictorial representation showing diffusion of a vulcanization reagent in an environment having a concentration gradient without a spatial labyrinth formed by labyrinthine material of the disclosed subject matter; and

FIG. 6B is a pictorial representation showing the diffusion of a vulcanization reagent in an environment having a concentration gradient through a spatial labyrinth formed by labyrinthine material of the disclosed subject matter.

Similar numerals and characters refer to similar components throughout the drawings

### DETAILED DESCRIPTION OF THE DISCLOSED SUBJECT MATTER

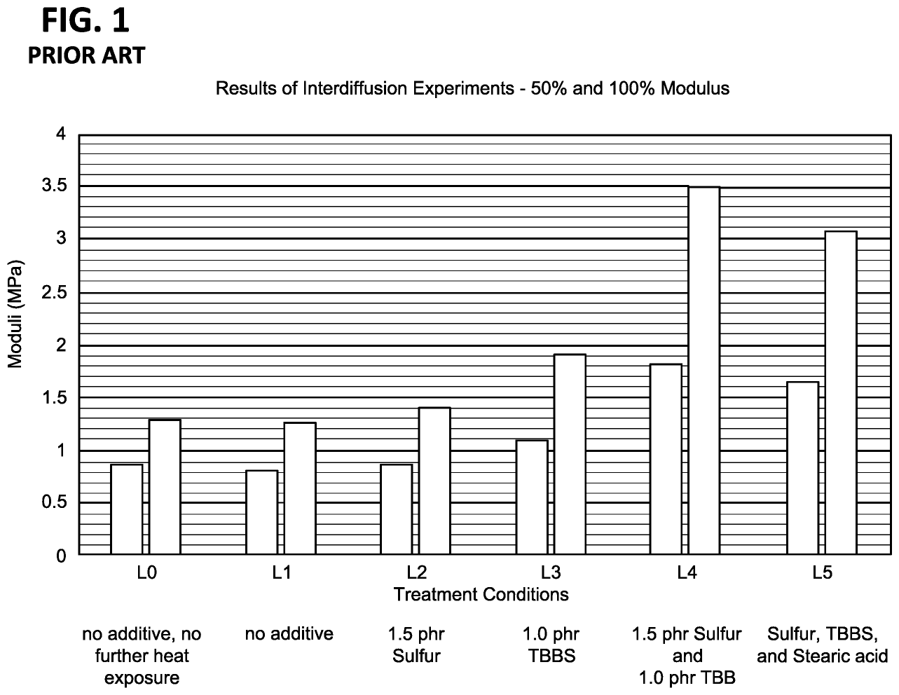

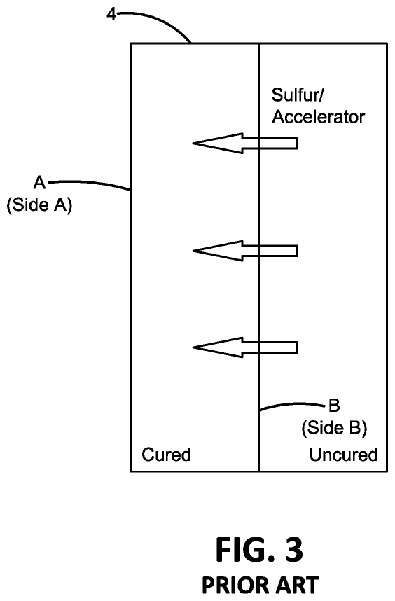

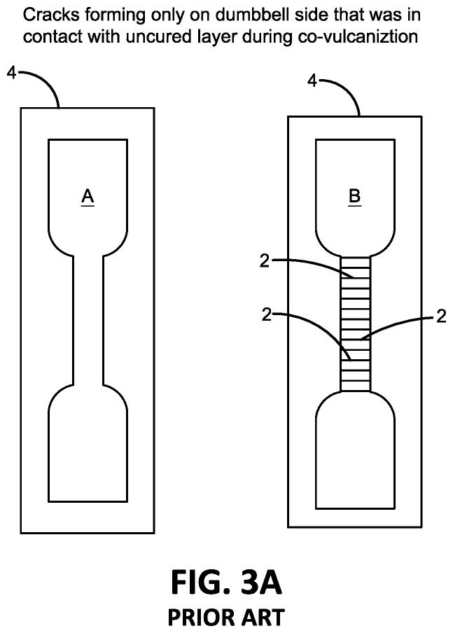

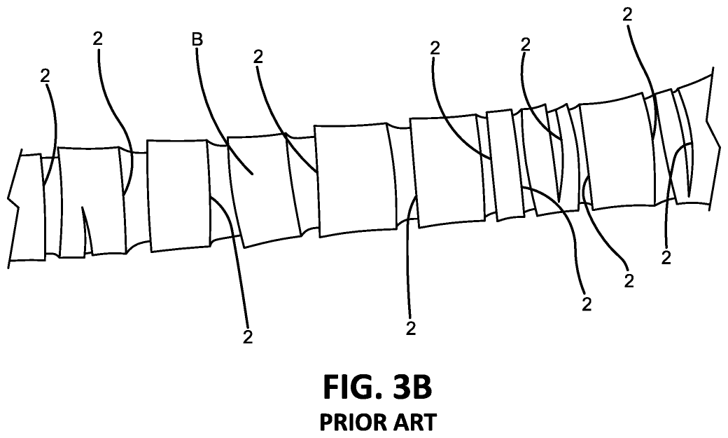

As indicated above, experiments have been carried out to identify and measure the additional cross-linking that occurs during inter-diffusion of cure additives to recycled rubber. For example, an experiment designed to simulate the environment in which ground recycled rubber is embedded in a fresh rubber compound during co-curing was conducted. In the experiment, as shown in FIG. 3, a sulfur-cured rubber sheet was placed on top of a 2 mm thick sheet of EPR (ethylene/propylene/copolymer) gum rubber which contained concentrations of additives that are normally used to vulcanize tire compounds, which included sulfur and cure accelerators, such as TBBS, along with ZnO and stearic acid. The cure additives induce additional cross-linking only in the previously cured rubber layer due to the saturated structure of the EPR layer. The EPR layer served as a fully accessible reservoir from which these additives could diffuse into the cured rubber layer, but the cure additives did not induce any reactions in the EPR layer as the EPR layer included a fully saturated structure. The two rubber layers were placed in a mold, compressed and exposed to temperatures of 160 degrees Celsius for 25 minutes, which is typical for curing. The EPR layer was subsequently peeled off, as shown in FIG. 3A, and stress strain tests were performed on the treated rubber layer using micro-dumbbells, as shown in FIG. 3A. The 50% and 100% moduli were used as a relative measure of cross-link density. The results of the experiment are set forth in FIG. 1.

The experiment shows that the addition of heat alone (L1) will not result in a change in modulus relative to the L0 control, but small increases in modulus occurred with the addition of sulfur (L2). Greater increases were realized with the inter-diffusion of the TBBS cure accelerator alone (L3), and increases greater than 100% occurred in the L4 laminate in which both sulfur and a cure accelerator inter-diffused. The consequence is that the addition of cure accelerating ingredients during the vulcanization process increases the number of cross-links within the recycled rubber. Similar increases in moduli are expected to be induced in ground recycled rubber particles during vulcanization of the recycled rubber

As earlier indicated, recent studies have shown that incorporation of previously cured rubber into uncured rubber generally results in a large decrease in performance of the resulting product. A study was thus conducted to illustrate the decrease in performance based on basic failure properties, such as tensile strength and elongation at break. In the study, ground rubber particles of different types, sizes, and compositions were used, including those obtained from cryogenically grinding end-of-life (“ELT”) truck tires and miscellaneous other ELT tires. Also used in the study were different concentrations of glass spheres, 250 micrometer in diameter. All were added to and co-cured with a carbon black reinforced F3 polybutadiene-based rubber compound (“PBD rubber”) according to the compositions/concentrations indicated in Table 1 below.

TABLE 1

| | Compounds | | | | |
|---|---|---|---|---|---|
| | F3 Control | | with GRP | with GRP | |
| | Compound | | from | from | with glass |
| | | with F3 | truck | other | micro |
| | w/o GRP | GRP | tires | tires | spheres |
| Components | (phr) | | (phr) | (phr) | (phr) |
| Polybutadiene | 100 | 100 | 100 | 100 | 100 |
| Carbon Black | 50 | 50 | 50 | 50 | 50 |
| Stearic Acid | 2 | 2 | 2 | 2 | 2 |
| GRP from F3 | | 16 | | | |
| control | | | | | |
| GRP from truck | | | 16 | | |
| tires-40, 80 and | | | | | |
| 120 mesh size | | | | | |
| GRP from misc. | | | | 16 | |
| tires (140 and | | | | | |
| 240 mesh) | | | | | |
| Glass micro | | | | | 1.3, 3.5, and |
| spheres 250 μm | | | | | 6.0 vol % |
| ZnO | 2 | 2 | 2 | 2 | 2 |
| Stearic acid | 2 | 2 | 2 | 2 | 2 |
| Antioxidant | 1 | 1 | 1 | 1 | 1 |
| Sulfur | | | | | |
| TBBS | | | | | |

Subsequent to co-curing of the ground rubber particles/glass spheres with the PBD rubber compounds, tensile tests were performed in uniaxial deformation using micro-dumbbells.

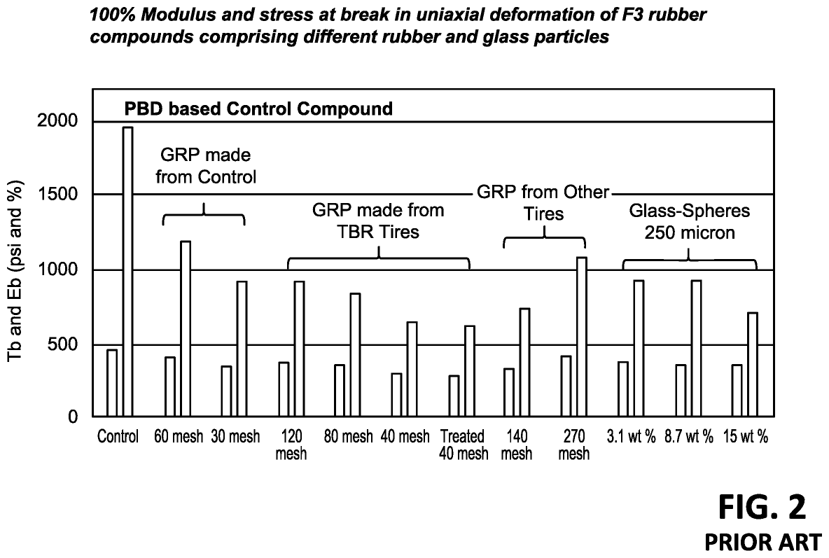

The results of the study are depicted in FIG. 2, which compares all of the tensile stress at break and elongation at break of the compositions with that of a PBD rubber control compound (F3) that does not contain any ground rubber particles, and two other control compounds of F3 compositions comprising 16 phr ground rubber particles having respective 30 and 60 mesh diameters that were freshly mixed, vulcanized and cryogenically ground. Several key findings from the study stood out. Specifically, adding 16 phr of ground rubber particles from different ELT tires to the F3 control compound reduced the tensile strength by up to 69 percent (%), with the level of reduction depending on particle size.

More surprising was that an addition to the F3 host control compound of freshly prepared ground rubber particles prepared from recently mixed and cured F3 compound also showed significant tensile strength losses, only modestly lower than those induced by particles from ELT tires. With host compound and ground rubber particles having identical composition and all being freshly prepared has not offered the co-vulcanizates much protected from tensile strength losses. The latter is further amplified by the results with glass spheres which do not bond to rubber compounds and show tensile strength losses equal to those of ELT tire particles at concentrations levels of as low as 3 weight percent (wt %). In that case, every glass particle represents an inherent defect that will lead to a rubber failure inducing crack at a given level of stress.

It has often been argued that the lower performance of rubber compounds containing ground rubber particles from spent tires is not surprising, given that these particles were part of a commercial tire that had undergone physical abuse, as well as heat and oxidative aging during the time of service on the roads. However, the data from the study indicated in FIG. 2 revealed that even if compositional and historical differences between the previously vulcanized ground rubber particles and the host matrix are removed, very significant performance issues remain. These performance issues appear to be a result of additional cross-linking of the previously vulcanized ground rubber particles.

The latter point was further supported by the results of additional experiments carried out with strips made from an L4 EPR gum compound that comprised only sulfur and TBBS accelerator (earlier described and used in FIG. 1) at concentrations equal to those used for preparing the cured F3 compound that was placed on top of it. Together they were subsequently co-vulcanized under pressure at 160° C. for 25 minutes as shown in FIG. 3. Dumbbells cut from the F3 sheet were then tensile tested at room temperature showing that the average tensile strength at break for the 4 samples tested was 718 psi compared to 2,100 psi measured for cured F3 dumbbells prior to co-vulcanization. Moreover, a high frequency sound was heard intermittently at a much lower stretch ratio. The likely origin revealed itself when the failed dumbbells were examined. As shown in FIG. 3B the dumbbell sample surface that had been in contact with the TPR layer during co-curing shows a series of shallow cracks (the sample was stretched by about 30% when the picture was taken to better visualize the crack geometry). No cracks or surface defects were visible on the opposite dumbbell side that had faced a side of the steel mold used for co-vulcanization. One must conclude that the inter-diffusing sulfur and TBBS accelerator had caused significant further crosslinking in a relatively thin surface layer causing a multitude of near brittle cracks at low extensions that had emitted the earlier mentioned high-frequency sound. The sample apparently continued to elongate until one of these shallow cracks propagated causing dumbbell failure.

Fundamentally what takes place during the co-vulcanization of the laminar strips is very similar to the experience of a cured rubber particle, originating from an ELT tire, when imbedded in a fresh rubber compound during recycling.

Based on the results, one can conclude that similar crosslink density and stiffness increases will occur when ground recycled rubber particles imbedded in an uncured host rubber compound are co-cured during recycling, for example, when a cured rubber particle originating from an ELT tire is recycled into a fresh rubber compound.

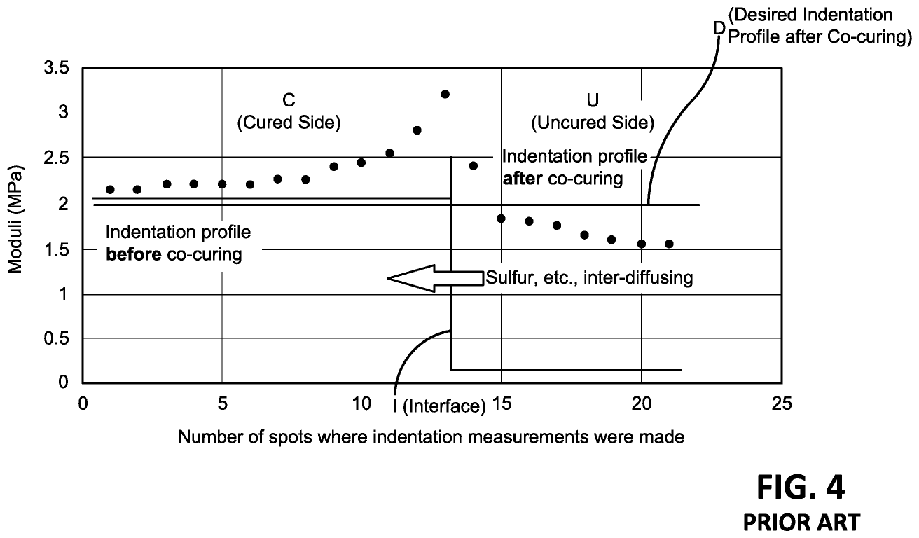

FIG. 4 depicts a typical crosslink density gradient across the co-cured layers of fresh rubber labeled “U” for uncured and recycled rubber labeled “C” for cured measured by Young's modulus measurements across the interface using micro-indentation equipment. Before co-vulcanization the cure state would be represented by the blue line, a fully cured state of the left rubber strip with no free sulfur present and no cure in the right strip but with a full-load of well dispersed sulfur. This sulfur and cure accelerator concentration gradient will remain mostly intact until the laminate is heated under pressure permitting a flux of sulfur and accelerator to diffuse into the cured matrix of the left strip and within a short time new crosslinks also form in the cured layer. There the access crosslinks formed can be qualitatively estimated by comparing the shaded area on the left (the new crosslinks) with the area on the right (crosslinks not formed due to sulfur diffusion). As anticipated measurements with a nano-indentation devise showed a narrower peak very close to the interface caused by the sudden burst of sulfur flux. What one would want to approach by co-curing is an equal crosslink density on both sides which is a key subject of this invention.

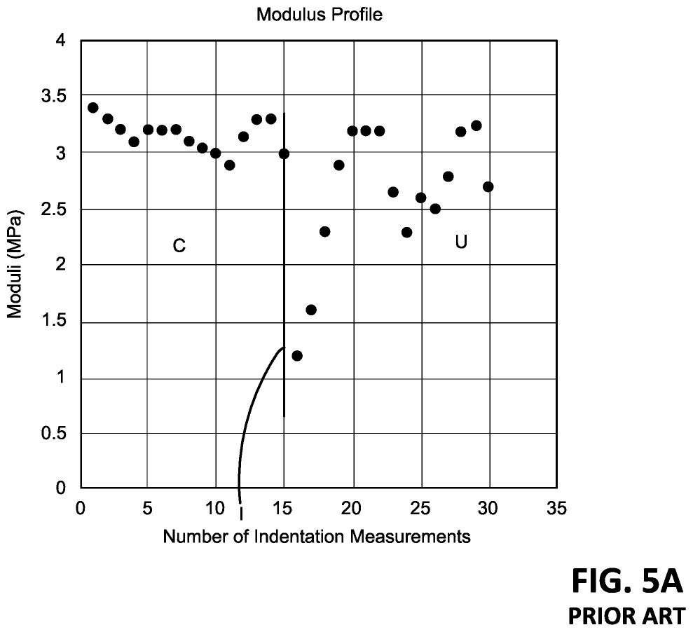

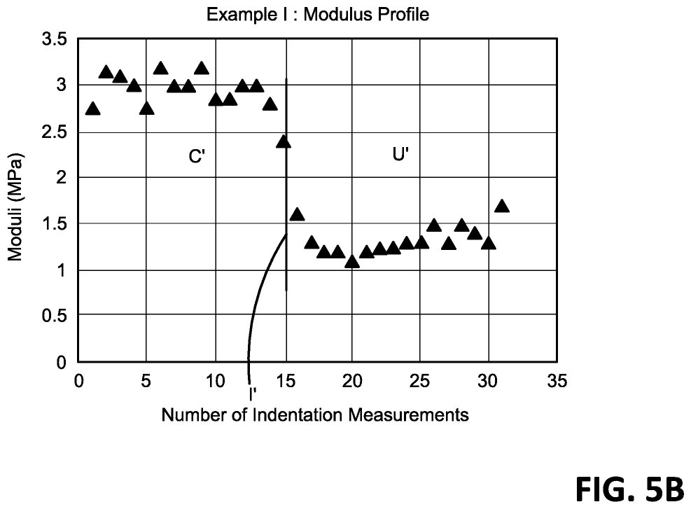

Turning now to FIG. 5A another microindentation study was conducted on previously vulcanized and fresh rubber laminates that were co-cured together. The results show that both the previously vulcanized and the fresh rubber laminates experienced a higher modulus than the desired modulus of about 2 MPa. It is contemplated that the higher modulus in the previously vulcanized laminate is due to additional sulfur crosslinks that develop in the previously vulcanized rubber laminate during the subsequent co-cure of the two samples.

Thus, a need exists in the art for a method for recycling rubber that significantly increases adhesion and bonding between the recycled previously vulcanized sulfur-cured rubber and fresh rubber and minimizes or eliminates secondary vulcanization of the recycled sulfur-cured rubber upon subsequent co-curing with fresh rubber. A need also exists in the art for a method for recycling rubber that provides a recycled rubber product with increased performance to those which utilize untreated and unmodified sulfur-cured rubber and comparable performance to rubber products which only use fresh rubber. There also exists a need in the art for a method for recycling rubber that allows a greater percentage of recycled rubber to be utilized in the rubber recycling process compared to prior art recycling methods, while providing a recycled rubber product with comparable or increased performance. In addition, there is also a need in the art for a method for recycling rubber that eliminates the need to fully devulcanize the recycled rubber prior to subsequent co-curing with fresh rubber to eliminate an often complex and expensive step, thereby decreasing recycling operation costs. The method for recycling rubber of the disclosed subject matter satisfies these needs, and will now be described.

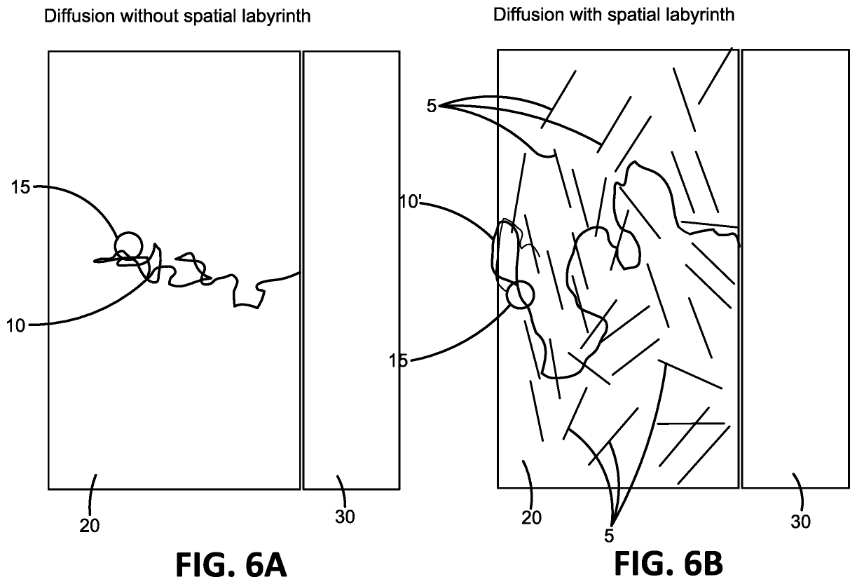

The method for recycling rubber of the disclosed subject matter utilizes a labyrinthine or barrier forming material to treat rubber compositions comprising sulfur-cured rubber or previously vulcanized rubber for use in rubber recycling processes. The labyrinthine material is a nano or micro-sized platelet that is utilized to create a spatial labyrinth around the vulcanized rubber, which reduces the diffusion of materials into the polymeric matrix of the vulcanized rubber. More specifically, as shown in FIGS. 6B, the nano or micro-sized platelets (5), function as a barrier around the vulcanized rubber (30) that creates a spatial labyrinth that controls and/or restricts diffusion of materials (15), into the polymeric matrix by increasing the travel path (10′) required for the materials to reach the polymeric matrix from a higher concentration region (20), as compared to the relatively direct travel path (10) of the materials (15) from the higher concentration region (20) to the vulcanized rubber (30) without the presence of the nano or micro-sized platelets (5) forming the spatial labyrinth, as shown in FIG. 6A. For example, the labyrinthine material can be utilized to control and/or restrict the diffusion of vulcanization inducing chemicals, such as sulfur, accelerators, etc., into surface-devulcanized ground rubber particles such that they are maintained within the fresh rubber compound or enter only into the surface-devulcanized area of the polymeric matrix and do not enter the vulcanized area of the polymeric matrix to significantly minimize or eliminate a secondary vulcanization of the recycled sulfur-cured rubber upon subsequent co-curing with fresh rubber, thereby preventing stiffness gradients in the co-cured composite that may propagate the formation of microcracks that could grow and potentially cause product failure.

The nano or micro-sized platelets can be any exfoliable crystalline structure capable of forming a spatial labyrinthine structure around the vulcanized rubber, such as graphene, graphene oxide, mica, clay, or other similar materials. The nano or micro-sized platelets preferably are relatively neutral in charge, with interaction between the vulcanized rubber and/or host rubber and the nano or micro-sized platelets being predominately limited to Van der Waals forces, but it is contemplated that the nano or micro-sized platelets could be functionalized to promote adhesion or increase compatibility of the platelets with the vulcanized rubber and/or host rubber and/or provide other desired performance related characteristics. The nano or micro-sized platelets preferably include a large surface area, with optimum benefits provided when platelet thickness is monoatomic, which, for example, can be achieved with graphene and graphene oxide to provide a surface area coverage or surface area/weight ratio of greater than about 500 m2/g, preferably greater than about 1000 m2/g, and more preferably greater than about 2000 m²/g. The spatial labyrinth formed by the nano or micro-sized platelets preferably is accomplished by using a minute volume fraction of the nano platelets relative to the concentration of the vulcanized rubber and fresh rubber with which the vulcanized rubber is co-cured during a rubber recycling process, but could include greater concentrations relative to the concentration of vulcanized rubber and fresh rubber without affecting the overall concept or operation of the disclosed subject matter. The spatial labyrinth is preferably formed with platelets that are well dispersed within the vulcanized rubber and/or host rubber, and which are comprised of only a few monoatomic layers optimally selected for the particular application and compatibility with the vulcanized rubber and/or host material they are embedded within.

The method for recycling rubber of the disclosed subject matter generally includes the steps of providing a recycled rubber compound, grinding the recycled rubber compound to form a plurality of ground rubber particles, providing a fresh rubber compound, adding a suitable amount of barrier forming material to the fresh rubber compound, mixing the plurality of ground rubber particles with the fresh rubber compound, and co-curing the mixture of the plurality of ground rubber particles with the fresh rubber compound to provide a recycled rubber product. The barrier forming material provides a barrier to the ground rubber particles upon mixing with the fresh rubber compound, which functions as a labyrinthine barrier that restricts and/or influences diffusion of materials, such as vulcanization reagents, through the polymeric matrix of the ground rubber particles to minimize secondary vulcanization of the ground rubber particles upon co-curing with the fresh rubber compound.

The method for using the labyrinthine material of the disclosed subject in rubber recycling processes generally also includes the method steps of providing a recycled rubber compound; grinding the recycled rubber compound to form ground rubber particles; providing a fresh rubber compound; adding a barrier forming material to the fresh rubber compound and limited amounts of Sulfur, cure accelerators and ZnO; mixing the devulcanized ground rubber particles and the fresh rubber compound; and inducing a mild vulcanization of the mixture of ground rubber particles and fresh rubber compound; grinding the mixture into small diameter particles; providing additional fresh rubber compound; co-vulcanizing the mixture of small diameter ground rubber particles and the fresh rubber compound.

### Example I

In an example method for recycling rubber employing the barrier or labyrinthine material for use in polymeric materials of the subject disclosure, recycled rubber is ground via suitable means, such as by cryogenic grinding, to produce ground recycled rubber particles, preferably with a particle size between thirty (30) to eighty (80) mesh. It is to be understood that recycled rubber can be ground to particles that include sizes larger than 30 mesh, such as 10 or 15, and/or smaller than 80 mesh, such as 100 or 150, without affecting the overall concept or operation of the disclosed subject matter. The ground recycled rubber particles preferably include a concentration of 5-10 phr, and more preferably include a concentration of 20-30 phr.

The ground recycled rubber particles are mixed with a suitable amount of fresh or virgin rubber compound containing nano or micro-sized platelets of graphene oxide. It is preferred that the graphene oxide is an atomic monolayer platelet having a single layer as this provides the largest possible surface area and as a result allows minimal diffusion during mixing of the components. More specifically, prior to mixing with the ground recycled rubber particles, a suitable amount of nano or micro-sized platelets of graphene oxide are mixed with the fresh rubber compound, preferably via high sheer mixing, such that the graphene oxide is uniformly dispersed within the fresh rubber compound and the graphene oxide surrounds the ground recycled rubber particles to form a spatial labyrinth upon mixing with the fresh rubber compound, thus producing a treated mixture of ground recycled rubber particles and fresh rubber compound. The concentration of graphene oxide is preferably within the range of about 0.5 weight percent (wt %) to about 5 weight percent (wt %), and more preferably within the range of about 0.5 weight percent (wt %) to about 2 weight percent (wt %). The concentration of graphene oxide utilized to form the spatial labyrinth preferably is a minute volume fraction relative to the concentration of the ground recycled rubber particles and fresh rubber compound, which preferably provides a spatial labyrinth of graphene oxide two (2) to four (4) layers thick. It is to be understood that thinner layers of graphene oxide are generally preferred as they can act as an effective barrier, but utilize less barrier material to accomplish the same or similar result. It is to be understood that a single (1) layer of graphene oxide or more than four (4) layers of graphene oxide may be utilized to form the spatial labyrinth without affecting the overall concept or operation of the disclosed subject matter. It is also to be understood that the graphene oxide platelets can have varying sizes and/or thicknesses without affecting the overall concept or operation of the disclosed subject matter.

A suitable mixture/concentration of vulcanization reagents, including sulfur, cure accelerators, such as TBBS, zinc oxide, stearic acid, and filler, such as carbon black or silica, are subsequently mixed with the treated mixture of ground recycled rubber particles and fresh rubber compound, which are subsequently co-cured via a suitable co-curing process to produce a desired recycled rubber product.

FIG. 5B depicts the crosslinking gradient across co-cured laminate strips of fresh rubber and recycled rubber, measured by microindentation measurements across the interface between the two layers, in accordance with the method of Example I utilizing 2 weight percent (wt %) graphene oxide as the labyrinthine material. With regard to the microindentation data presented in FIG. 5B, the fresh rubber strip is indicated by area U′ and the previously vulcanized recycled rubber strip is indicated by area C′. The interface between the fresh rubber strip and a previously vulcanized recycled rubber strip is indicated by reference character I′.

As is shown by the results, area C′ of the previously vulcanized recycled rubber strip adjacent interface I′ lacks a spike in modulus indicative of additional crosslinks generated by sulfur that diffused from the previously un-cured fresh rubber strip to the previously vulcanized recycled rubber strip near the interface and/or carbon black flocculation near the interface due to devulcanization. While the degree of curing on the two sides of interface I′ between the fresh rubber and previously vulcanized recycled rubber strip appears different, each of the co-cured fresh rubber and previously vulcanized recycled rubber strips have even cure levels, i.e., without peaks and valleys. The degree of curing on the two sides of interface I′ between the fresh rubber and previously vulcanized recycled rubber strip could be adjusted such that the curing is similar upon co-curing. These findings are in sharp contrast to the modulus profile of FIG. 5A, which shows the micro-indentation data for a near identical two-layer laminate in which the uncured rubber strip did not contain any graphene-oxide. As is shown in FIG. 5A, a sharp drop in modulus is present on the uncured side U, close to the interphase I, which suggests that significant sulfur levels had diffused into the previously cured side C, contributing to a modulus spike induced by new crosslinking. The 0.5 MPa spike shown in FIG. 5A measured by micro-indentation measurements has generally shown itself as a higher, but narrower peak when analyzed with nano-indentation equipment.

Because the graphene oxide platelets form a spatial labyrinth around the ground recycled rubber particles, the diffusion of sulfur, cure accelerators, and/or other vulcanization reagents into the ground recycled rubber particles is controlled and/or restricted from entering the vulcanized area of the polymeric matrix, even if encouraged to diffuse therewithin because of existing concentration gradients (See FIGS. 6A and 6B). Consequently, secondary vulcanization of the ground recycled rubber particles upon co-curing with the fresh rubber compound is significantly minimized or eliminated, and the cross-link densities across the interfaces of the co-cured ground rubber particles and fresh rubber compound are relatively uniform. This provides a recycled rubber product that exhibits increased performance to those which utilize untreated and unmodified recycled rubber and comparable performance to rubber products which only use fresh rubber, allows a greater percentage of recycled rubber to be utilized in the rubber recycling process compared to prior art recycling methods, while providing comparable or increased performance, as well as eliminates the need to devulcanize the recycled rubber prior to subsequent co-curing with fresh rubber, as required by other prior art rubber recycling processes, thereby eliminating an often complex and expensive step and decreasing the recycling operation costs. In addition, in applications where the recycled rubber product is a tire, because graphene oxide is utilized as the labyrinthine material, the graphene interferes with undesirable flocculation of the filler, such as carbon black, which in turn desirably reduces the rolling resistance of the tire.

Alternatively, the ground recycled rubber particles may be treated by a bonding enhancing process prior to mixing with the fresh rubber compound. Such bonding enhancing process can be via devulcanization or other bonding promoting processes, preferably a suitable surface devulcanization process, such as the process described in U.S. Pat. No. 11,434,353, which was issued on Sep. 6, 2022, and is assigned to Applicant of the instant application. With such a bonding enhancing process, because the ground recycled rubber particles are surface-devulcanized prior to co-curing with the fresh rubber compound, strong tack between the mixed ground recycled rubber and fresh rubber compound is generated, which provides optimal adhesion between the recycled rubber and fresh rubber compound upon co-curing.

### Example II

In another example method for recycling rubber employing the labyrinthine material for use in polymeric materials of the subject disclosure, recycled rubber is ground via suitable means, such as by cryogenic grinding, to produce ground recycled rubber particles, preferably with a particle size between thirty (30) to eighty (80) mesh. It is to be understood that recycled rubber can be ground to particles that include sizes larger than 30 mesh, such as 10 or 15, and/or smaller than 80 mesh, such as 100 or 150, without affecting the overall concept or operation of the disclosed subject matter. The ground recycled rubber particles preferably include a concentration of 5-10 phr, and more preferably include a concentration of 20-30 phr.

The ground recycled rubber particles are mixed with a suitable amount of fresh or virgin rubber compound containing nano or micro-sized platelets of graphene oxide. It is preferred that the graphene oxide is an atomic monolayer platelet having a single layer as this provides the largest possible surface area and as a result allows minimal diffusion during mixing of the components. More specifically, prior to mixing with the ground recycled rubber particles, a suitable amount of nano or micro-sized platelets of graphene oxide are mixed with the fresh rubber compound, preferably via high sheer mixing, such that the graphene oxide is uniformly dispersed about the fresh rubber compound and the graphene oxide surrounds the ground rubber particles to form a spatial labyrinth upon mixing with the fresh rubber compound. The concentration of graphene oxide is preferably within the range of about 0.5 weight percent (wt %) to about 5 weight percent (wt %), and more preferably within the range of about 0.5 weight percent (wt %) to about 2 weight percent (wt %). The concentration of graphene oxide utilized to form the spatial labyrinth preferably is a minute volume fraction relative to the concentration of the fresh rubber compound, which preferably provides a spatial labyrinth of graphene oxide two (2) to four (4) layers thick. It is to be understood that thinner layers of graphene oxide are generally preferred as they can act as an effective barrier, but utilize less barrier material to accomplish the same or similar result. It is to be understood that a single (1) layer of graphene oxide or more than four (4) layers of graphene oxide may be utilized to form the spatial labyrinth without affecting the overall concept or operation of the disclosed subject matter. It is also to be understood that the graphene oxide platelets can have varying sizes and/or thicknesses without affecting the overall concept or operation of the disclosed subject matter.

In addition, prior to mixing with the ground recycled rubber particles, and after the graphene oxide is added to the fresh rubber compound, a limited amount of vulcanization reagents, including sulfur, a cure accelerator(s), such as TBBS, and zinc oxide, are mixed with fresh rubber compound, thus producing a treated mixture of surface-devulcanized ground recycled rubber particles and fresh rubber compound, so as to preferably reduce cure state by about 15 percent (%) to about 70 percent (%), and more preferably by about 15 percent (%) to about 50 percent (%). After mixing, the treated mixture of surface-devulcanized ground recycled rubber particles are co-cured with the fresh rubber compound via a suitable co-curing process to induce mild vulcanization of the mixture, so as to preferably reduce cure state by about 15 percent (%) to about 70 percent (%), and more preferably by about 15 percent (%) to about 50 percent (%). The mildly co-cured mixture is subsequently ground into a plurality of small diameter particles, preferably within the range of about 20 mesh to about 120 mesh, and more preferably within the range of about 40 mesh to about 80 mesh. The small diameter particles are subsequently mixed with additional fresh rubber. A suitable mixture/concentration of vulcanization reagents, including sulfur, cure accelerators, such as TBBS, zinc oxide, stearic acid, and filler, such as carbon black or silica, are subsequently mixed with the mixture of small diameter particles and additional fresh rubber, which are subsequently co-cured via a suitable co-curing process to produce a desired recycled rubber product.

It is predicted that the degree of curing on the two sides of the interface between the fresh rubber and previously vulcanized recycled rubber will be nearly identical and will also lack a spike in modulus indicative of additional crosslinks generated by sulfur that diffused from the previously un-cured fresh rubber to the previously vulcanized recycled rubber near the interface.

With the method of recycling rubber of the discussed subject matter according to Example II, because the graphene oxide platelets form a spatial labyrinth around the surface-devulcanized ground recycled rubber particles upon mixing with the fresh rubber compound containing the graphene oxide platelets, the diffusion of sulfur, accelerators, and/or other vulcanization reagents into the surface-devulcanized ground recycled rubber particles is controlled and/or restricted from entering the vulcanized area of the polymeric matrix, even if encouraged to diffuse therewithin because of existing concentration gradients (See FIGS. 6A and 6B). Consequently, secondary vulcanization of the ground recycled rubber particles upon co-curing with the fresh rubber compound is significantly minimized or eliminated, and the cross-link densities across the interfaces of the co-cured surface-devulcanized ground rubber particles and fresh rubber compound are relatively uniform. In addition, because the ground recycled rubber particles are surface-devulcanized prior to co-curing with the fresh rubber compound, strong tack between the mixed ground recycled rubber and fresh rubber compound is generated, which provides optimal adhesion between the recycled rubber and fresh rubber compound. Moreover, because the treated mixture of surface-devulcanized ground recycled rubber particles are co-cured with the fresh rubber compound via a suitable co-curing process to induce mild vulcanization of the mixture, and the mixture is subsequently ground into a plurality of small diameter particles that are mixed and co-cured with additional fresh rubber compound, increased bond strength between the surface-devulcanized ground recycled rubber particles and the fresh rubber compound is provided. This provides a recycled rubber product that exhibits increased performance to those which utilize untreated and unmodified recycled rubber and comparable performance to rubber products which only use fresh rubber, allows a greater percentage of recycled rubber to be utilized in the rubber recycling process compared to prior art recycling methods, while providing comparable or increased performance, as well as eliminates the need to fully devulcanize the recycled rubber prior to subsequent co-curing with fresh rubber, as required by other prior art rubber recycling processes, thereby eliminating an often complex and expensive step and decreasing the recycling operation costs. In addition, in applications where the recycled rubber product is a tire, because graphene is utilized as the labyrinthine material, the graphene interferes with undesirable flocculation of the filler, such as carbon black, which in turn desirably reduces the rolling resistance of the tire.

### CONCLUSION

Thus, the method for recycling rubber of the disclosed subject matter significantly minimizes or eliminates secondary vulcanization of recycled sulfur-cured rubber upon co-curing with fresh rubber. Furthermore, the method for recycling rubber of the disclosed subject matter provides a recycled rubber product with increased performance to those which utilized untreated or unmodified recycled rubber compounds and comparable performance to rubber products which only use fresh rubber. In addition, the method for recycling rubber of the disclosed subject matter provides increased bond strength between the ground recycled rubber particles and the fresh rubber compound and allows a greater percentage of recycled rubber to be utilized in rubber recycling processes compared to prior art recycling methods, while providing a recycled rubber product with comparable or increased performance. The method for recycling rubber of the disclosed subject matter also eliminates the need to fully devulcanize the recycled sulfur-cured rubber prior to subsequent co-curing of the recycled rubber and fresh rubber, thereby eliminating an often complex and expensive step and decreasing the recycling operation costs.

It should be understood that the labyrinthine material of the subject disclosure is a nano or micro-sized platelet that is utilized to create a spatial labyrinth around a polymeric matrix in order to reduce or influence diffusion of materials into the polymeric matrix. As such, any nano or micro-sized platelet having an exfoliable crystalline structure capable of forming a spatial labyrinthine structure around the polymeric matrix, such as graphene, graphene oxide, mica, clay, or any other similar exfoliable crystalline structure, would be suitable and could be utilized in the subject disclosure.

Likewise, it is also understood that the subject disclosure can be utilized with any type of polymeric matrix, such as those utilized in tire manufacturing or design of special multilayer composites, without changing the overall concept or operation of the subject disclosure.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the disclosed subject matter has been described with reference to specific embodiments. It shall be understood that these illustrations are by way of example and not by way of limitation, as the scope of the disclosed subject matter is not limited to the exact details shown or described. Potential modifications and alterations will occur to others upon a reading and understanding of this disclosure, and it is understood that the disclosed subject matter includes all such modifications and alterations and equivalents thereof.

Having now described the features, discoveries and principles of the disclosed subject matter, the manner in which the method for recycling rubber of the disclosed subject matter is used and installed, the characteristics of the construction, arrangement and method steps, and the advantageous, new and useful results obtained; the new and useful structures, devices, elements, arrangements, processes, parts and combinations are set forth in the appended claims.

What is claimed is:

1. A method for recycling a vulcanized rubber compound comprising the following steps:
a.) providing a recycled rubber compound;
b.) grinding said recycled rubber compound to form a plurality of ground rubber particles;
c.) providing a fresh rubber compound;
d.) adding a suitable amount of barrier forming material to said fresh rubber compound;
e.) mixing said plurality of ground rubber particles with the said fresh rubber compound; and
f) co-vulcanizing said mixture of the plurality of ground rubber particles with said fresh rubber compound.

2. The method for recycling a vulcanized rubber compound of claim 1, wherein said barrier forming material is selected from the group consisting of clay, mica, graphene, and graphene-oxide.

3. The method for recycling a vulcanized rubber compound of claim 2, wherein said barrier forming material includes a surface/weight ratio of greater than about 500 m²/g.

4. The method for recycling a vulcanized rubber compound of claim 3, wherein said step of adding said barrier forming material to said fresh rubber compound further includes employing means to ensure a high degree of micro dispersion of the barrier forming material in the fresh rubber compound.

5. The method for recycling a vulcanized rubber compound of claim 4, wherein a graphene-oxide/sulfur composition is employed to achieve said high degree of micro dispersion of said barrier forming material in said fresh rubber compound.

6. The method for recycling a vulcanized rubber compound of claim 1, wherein said barrier forming material includes a concentration of about 0.5 weight percent (wt %) to about 5 weight percent (wt %).

7. The method for recycling a vulcanized rubber compound of claim 1, wherein said barrier forming material includes a concentration of about 0.5 weight percent (wt %) to about 2 weight percent (wt %).

8. The method for recycling a vulcanized rubber compound of claim 1, further comprising treating said plurality of ground rubber particles with a devulcanization agent that preferably induces surface devulcanization of the plurality of ground rubber particles;

9. A method for recycling a vulcanized rubber compound comprising the following steps:
a.) providing a recycled rubber compound;
b.) grinding said recycled rubber compound to form a plurality of ground rubber particles;
c.) providing a fresh rubber compound;
d.) adding a suitable amount of barrier forming material to said fresh rubber compound;
e.) adding limited amounts of sulfur, a cure accelerator, and zinc oxide to the fresh rubber compound;
f) mixing said treated plurality of ground rubber particles with said fresh rubber compound;
g.) inducing a mild vulcanization of said mixture of the treated plurality of ground rubber particles and the fresh rubber compound; and
h.) grinding the mixture into small diameter particles.

10. A modified rubber compound produced according to the method set forth in claim 9.

11. The method for recycling a vulcanized rubber compound of claim 9, further comprising the following steps:
i.) mixing additional fresh rubber compound with said small diameter particles; and
j.) co-vulcanizing the small diameter particles and said additional fresh rubber.

12. The method for recycling a vulcanized rubber compound of claim 11, wherein said barrier forming material is selected from the group consisting of clay, mica, graphene, and graphene-oxide.

13. The method for recycling a vulcanized rubber compound of claim 11, wherein said barrier forming material provides a surface/weight ratio greater than about 500 m²/g.

14. The method for recycling a vulcanized rubber compound of claim 11, wherein said step of adding said barrier forming material to said fresh rubber compound further includes employing means to ensure a high degree of micro dispersion of the barrier forming material in the fresh rubber compound.

15. The method for recycling a vulcanized rubber compound of claim 14, wherein a graphene-oxide/sulfur composition is employed to achieve said high degree of micro dispersion of said barrier forming material in said fresh rubber compound.

16. The method for recycling a vulcanized rubber compound of claim 11, wherein said barrier forming material includes a concentration of about 0.5 weight percent (wt %) to about 5 weight percent (wt %).

17. The method for recycling a vulcanized rubber compound of claim 11, wherein said barrier forming material includes a concentration of about 0.5 weight percent (wt %) to about 2 weight percent (wt %).

18. The method for recycling a vulcanized rubber compound of claim 11, wherein said limited amounts of said sulfur, said cure accelerator, and said zinc oxide and said mild vulcanization reduces a cure state of said mixture of the treated plurality of ground rubber particles and said fresh rubber compound by about 15 percent (%) to about 70 percent (%).

19. The method for recycling a vulcanized rubber compound of claim 11, wherein said limited amounts of said sulfur, said cure accelerator, and said zinc oxide and said mild vulcanization reduces a cure state of said mixture of the treated plurality of ground rubber particles and said fresh rubber compound by about 15 percent (%) to about 50 percent (%).
